(19) United States
(12) Patent Application Publication
(10) Pub. No.: US 2026/0251796 A1
(43) Pub. Date: Aug. 27, 2026

(54) CIRCUITRY AND METHOD

(71) Applicant: Sony Semiconductor Solutions Corporation, Atsugi-shi, Kanagawa (JP)

(72) Inventor: Victor BELOKONSKIY, Basingstoke (GB)

(73) Assignee: Sony Semiconductor Solutions Corporation, Atsugi-shi, Kanagawa (JP)

(21) Appl. No.: 19/161,324

(22) PCT Filed: Mar. 5, 2024
(86) PCT No.: PCT/EP2024/055709

§ 371 Date: Sep. 2, 2025

(30) Foreign Application Priority Data
Mar. 10, 2023 (EP) 23161266.4

(51) Int. Cl. G01S 17/894; G01S 7/4915

(52) U.S. Cl. CPC G01S 17/894; G01S 7/4915

(57) ABSTRACT

The disclosure pertains to a time-of-flight image sensor circuitry that includes an imaging unit with a first imaging portion and a second imaging portion, wherein the circuitry is further configured to apply a low-frequency demodulation signal that has a first state and a second state, and apply a high-frequency demodulation signal, wherein, when the low-frequency demodulation signal is applied in the first state to the first imaging portion, the high-frequency demodulation signal is applied to the second imaging portion.

### TECHNICAL FIELD

The present disclosure generally pertains to a circuitry and a method, in particular, to a time-of-flight image sensor circuitry and a time-of-flight image sensor circuitry control method.

### TECHNICAL BACKGROUND

It is generally known to perform imaging with an image sensor. For example, indirect time-of-flight (i-ToF) includes emitting a modulated illumination signal into a scene and imaging the scene by photoelectric conversion of light received from the scene in pixels of an image sensor. The pixels include a plurality of floating diffusions and switch, while imaging the scene, between floating diffusions of the plurality of floating diffusions for storing charges generated by the photoelectric conversion according to a demodulation signal that corresponds to the modulated illumination signal emitted into the scene.

A roundtrip time of the emitted modulated illumination signal to an object in the scene and its reflection to the image sensor results in a phase shift between the demodulation signal and the reflected signal received from the scene. Due to the phase shift, a ratio of charges stored in the plurality of floating diffusions of a pixel corresponds to a distance of an object in the scene that has reflected the emitted modulated illumination signal to the image sensor. Thus, depth data that correspond to distances of objects in the scene can be determined for the pixels, and a depth map of the scene can be generated based on depth data of the pixels.

Although there exist techniques for i-ToF, it is generally desirable to provide an improved time-of-flight image sensor circuitry and an improved time-of-flight image sensor circuitry control method.

### SUMMARY

According to a first aspect, the disclosure provides a time-of-flight image sensor circuitry, comprising an imaging unit including a first imaging portion and a second imaging portion, wherein the circuitry is further configured to: apply a low-frequency demodulation signal having a first state and a second state, and apply a high-frequency demodulation signal, wherein, when the low-frequency demodulation signal is applied in the first state to the first imaging portion, the high-frequency demodulation signal is applied to the second imaging portion.

According to a second aspect, the disclosure provides a time-of-flight image sensor circuitry control method for controlling a time-of-flight image sensor circuitry including an imaging unit including a first imaging portion and a second imaging portion, wherein the method further comprises: applying a low-frequency demodulation signal having a first state and a second state, and applying a high-frequency demodulation signal, wherein, when the low-frequency demodulation signal is applied in the first state to the first imaging portion, the high-frequency demodulation signal is applied to the second imaging portion.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 illustrates an overview of a time-of-flight image sensor circuitry according to an embodiment;

FIG. 2 illustrates a time-of-flight image sensor circuitry in more detail according to an embodiment;

FIG. 3 illustrates a time-of-flight image sensor circuitry control method according to an embodiment;

FIG. 4 illustrates four two-tap pixels according to an embodiment;

FIG. 5 illustrates a timing diagram in which a high-frequency demodulation signal is applied to two two-tap pixels and a low-frequency demodulation signal is applied to two two-tap pixels according to an embodiment;

FIG. 6 illustrates a timing diagram in which a high-frequency demodulation signal and a low-frequency demodulation signal are both applied to four two-tap pixels, wherein a phase shift of a Q signal for the low-frequency demodulation signal corresponds to a 90° phase shift, according to an embodiment;

FIG. 7 illustrates a timing diagram in which a high-frequency demodulation signal and a low-frequency demodulation signal are both applied to four two-tap pixels, wherein a phase shift of a Q signal for the low-frequency demodulation signal deviates from a 90° phase shift, according to an embodiment;

FIG. 8 illustrates two four-tap pixels according to an embodiment:

FIG. 9 illustrates a timing diagram in which a high-frequency demodulation signal is applied to a first four-tap pixel and a low-frequency demodulation signal is applied to a second four-tap pixel according to an embodiment;

FIG. 10 illustrates an embodiment of a smartphone and of smart glasses; and

FIG. 11 illustrates an embodiment of a general-purpose computer.

### DETAILED DESCRIPTION OF EMBODIMENTS

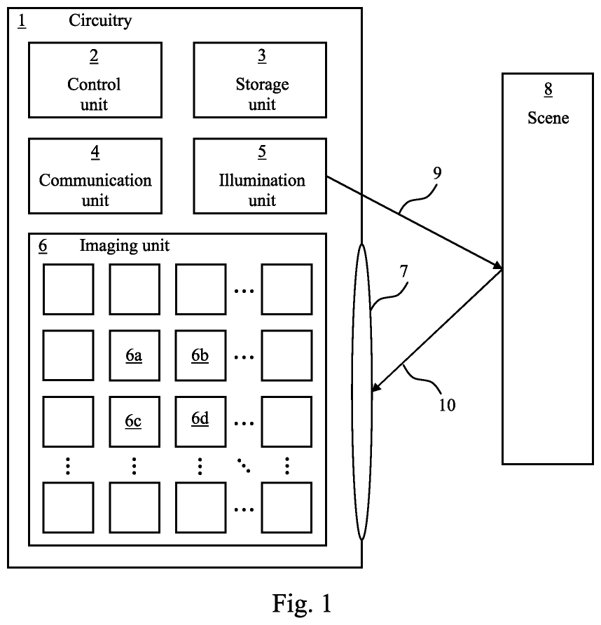

Before a detailed description of the embodiments under reference of FIG. 1 is given, general explanations are made.

As described in the outset, it is generally known to perform imaging with an image sensor. For example, indirect time-of-flight (i-ToF) includes emitting a modulated illumination signal into a scene and imaging the scene by photoelectric conversion of light received from the scene in pixels of an image sensor. The pixels include a plurality of floating diffusions and switch, while imaging the scene, between floating diffusions of the plurality of floating diffusions for storing charges generated by the photoelectric conversion according to a demodulation signal that corresponds to the modulated illumination signal emitted into the scene.

The plurality of floating diffusions of a pixel may also be referred to as taps. For example, a pixel of an i-ToF image sensor may include two taps or four taps. However, other numbers of taps are possible as well, and the present technology is not limited to two or four taps.

A roundtrip time of the emitted modulated illumination signal to an object in the scene and its reflection to the image sensor results in a phase shift between the demodulation signal and the reflected signal received from the scene. Due to the phase shift, a ratio of charges stored in the taps of a pixel corresponds to a distance of an object in the scene that has reflected the emitted modulated illumination signal to the image sensor. Thus, depth data that correspond to distances of objects in the scene can be determined for the pixels, and a depth map of the scene can be generated based on depth data of the pixels.

In some instances, a depth resolution of the generated depth data depends on a frequency of the emitted modulated illumination signal. For example, a higher frequency of the emitted modulated illumination signal may have a shorter modulation period than a lower frequency, and the delay of the reflected signal received from the scene with respect to the demodulation signal may correspond to a higher phase shift for the shorter modulation period than for a longer modulation period. The higher phase shift may allow a precise determination of shorter distances than for the lower frequency.

On the other hand, in some instances, a range in which a distance can be determined unambiguously is limited by a frequency of the emitted modulated illumination signal. For example, if the phase shift is too high, a conclusion from the ratio of charges stored in the taps of a pixel to the roundtrip time (and, thus, to a distance) may be ambiguous.

The range in which a distance can be determined unambiguously is increased in some embodiments by using a first demodulation signal that is in phase with the emitted modulated illumination signal and is called in-phase (I) signal, and using a second demodulation signal that is delayed by a phase shift of 90° with respect to the emitted modulated illumination signal and is called quadrature (Q) signal. For example, taps may be switched based on an I signal in a first exposure and based on a Q signal in a second exposure, and depth data may be generated based on a ratio of charges in the taps generated in the first exposure and on a ratio of charges in the taps generated in the second exposure.

In some instances, conventional i-ToF technology based on a two-tap pixel requires several (e.g., four) exposures (otherwise known as components or phases) in order to measure a phase of a reflected modulated illumination signal and derive a distance to an object at which the modulated illumination signal is reflected. In this way, in some instances, power consumption of the i-ToF image sensor is impacted (e.g., increased) by multiple data read-outs, and a depth precision of generated depth data is reduced. In some instances, another drawback is an increased motion blur of the measured depth due to the time/distance separation in used components and increased overall acquisition time caused by the multiple read-outs.

In some instances, another conventional technique that improves a depth precision at longer range by using two different modulation frequencies (high and low) even further increases the number of exposures to eight, thus additionally degrading power consumption and motion blur.

In some instances, a method to overcome the mentioned challenges is one-shot I/Q mosaic. With one-shot I/Q mosaic, half of the pixels in a pixel array of an i-ToF image sensor may be driven by 0° phase (I signal) of the modulation signal and another half may be driven by 90° phase (Q signal) of the modulation signal. The pixels may be interleaved, such that a full resolution depth may be restored based on a simple de-mosaic technique.

One-shot I/Q mosaic may work with a single modulation frequency. For dual frequency acquisition, two exposures may be necessary. Although one-shot I/Q mosaic may significantly improve the number of required exposures in comparison to the base method, remarkable motion blur artefacts still remain in some instances.

Consequently, some embodiments of the disclosure pertain to a time-of-flight (ToF) image sensor circuitry that includes an imaging unit with a first imaging portion and a second imaging portion, wherein the circuitry is further configured to apply a low-frequency demodulation signal that has a first state and a second state, and apply a high-frequency demodulation signal, wherein, when the low-frequency demodulation signal is applied in the first state to the first imaging portion, the high-frequency demodulation signal is applied to the second imaging portion.

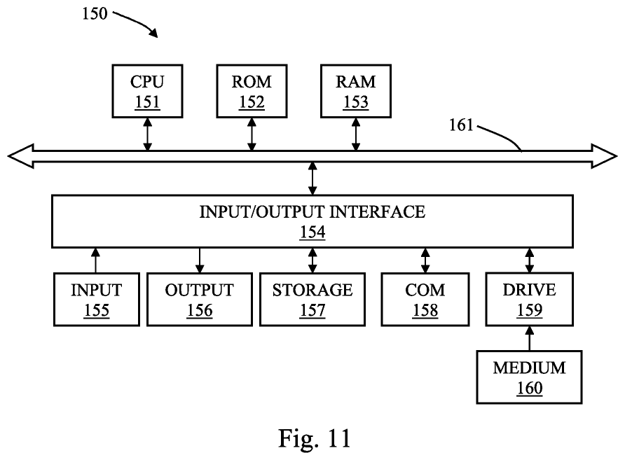

The circuitry may be implemented in any suitable way. For example, the circuitry may include a programmed microprocessor, an application-specific integrated circuit (ASIC), a field-programmable gate array (FPGA) and/or an arrangement of conventional circuit components. For example, the circuitry may include a general-purpose computer as described below with respect to FIG. 11.

The circuitry may include a storage unit for storing data such as, e.g., generated depth data, temporary data used for generating the depth data and/or instructions for controlling a function of the circuitry. The instructions may be generated based on a programming language such as Assembler, C/C++, Java, and/or the like. The storage unit may be based on flash memory, electrically erasable programmable read-only memory (EEPROM), dynamic random-access memory (DRAM) and/or the like.

For outputting generated depth data and/or a generated depth map, the circuitry may include a communication interface and/or a removable storage medium interface. The communication interface may be configured to output data via Camera Serial Interface (CSI), Ethernet, Controller Area Network (CAN), Wi-Fi (a standard of the IEEE 802.11 family), Bluetooth, Near Field Communication (NFC) and/or the like. The removeable storage medium interface may be configured to output data to a Universal Storage Bus (USB) drive, a Secure Digital (SD) memory card, a Digital Video Disc (DVD), a Compact Disc (CD), a magnetic tape, a floppy disk and/or the like.

The circuitry may further generate a modulation signal for controlling emission of a modulated illumination signal into a scene. The modulation signal may be modulated with a predefined modulation frequency and may, for example, indicate pulses of the modulated illumination signal. The circuitry may provide the generated modulation signal to an illumination unit. The illumination unit may include a laser diode (e.g., a vertical-cavity surface-emitting laser (VCSEL)), a light-emitting diode (LED) or the like, and may emit light into the scene according to the modulation signal. For example, the illumination unit may emit light when the modulation signal indicates a first state (e.g., assumes a first predefined voltage) and may not emit light when the modulation signal indicates a second state (e.g., assumes a second predefined voltage). The modulated illumination signal may include an infrared signal. The illumination unit may be included in the circuitry or may be provided separately from the circuitry.

The imaging unit may include one or more photosensitive elements (pixels). The photosensitive element(s) may include a complementary metal-oxide semiconductor (CMOS) sensor, a charge-coupled device (CCD) sensor and/or the like. If the imaging unit includes more than one pixel, these pixels may be arranged in an array, e.g., in a one- or two-dimensional array.

The first imaging portion and the second imaging portion may include a plurality of floating diffusions (taps) each. For example, each of the first and the second imaging portion may include two taps or may include four taps. However, the number of taps in the first imaging portion and in the second imaging portion is not limited to two or four. Any suitable number of taps may be provided in the first and the second imaging portion.

The first imaging portion and the second imaging portion may be included in the pixel(s). For example, in a case where the first and the second imaging portions include two taps each, the first and the second imaging portions may be provided in two adjacent pixels of the array (two-tap pixels), or may be provided in a same pixel of the imaging unit (four-tap pixel).

The first and the second imaging portions may be configured to store electric charges generated by a photoelectric conversion unit (e.g., by a photodiode) in their taps. The photodiode may be included in the first and in the second imaging portion, respectively, or may be provided separately in a pixel that includes the first and/or the second imaging portion, respectively.

The circuitry may additionally generate the low-frequency demodulation signal and the high-frequency demodulation signal. Both the low-frequency demodulation signal and the high-frequency demodulation signal may have a first state and second state. For example, the first and the second state may be represented by two different voltage values or voltage ranges, and the (low-frequency and/or high-frequency) demodulation signal may indicate the first or the second state by assuming a voltage that corresponds to the voltage value or voltage range associated with the first or second state, respectively. The low-frequency demodulation signal may assume the same or different voltages for the respective states as the high-frequency demodulation signal.

A frequency of the high-frequency demodulation signal may correspond to the predefined modulation frequency of the modulation signal for the modulated illumination signal. The first and the second state of the high-frequency demodulation signal may correspond to the first and the second state of the modulation signal, respectively. The frequency of the high-frequency demodulation signal may be an integer multiple of a frequency of the low-frequency demodulation signal. For example, a frequency ratio between the low-frequency demodulation signal and the high-frequency demodulation signal may be 1:6 or 1:10 or 1:14, without limiting the disclosure to these values.

For example, the modulation signal, the high-frequency demodulation signal and the low-frequency demodulation signal may have a duty cycle of 50% and may change between their respective first and second states when a respective half-period has elapsed.

The circuitry may apply the low-frequency demodulation signal to the first imaging portion in the first state of the low-frequency demodulation signal. For example, the circuitry may provide the low-frequency demodulation signal to the first imaging portion when the low-frequency demodulation signal assumes a voltage associated with the first state.

When applying the low-frequency demodulation signal to the first imaging portion in the first state, the circuitry may apply the high-frequency demodulation signal to the second imaging portion. For example, the circuitry may provide the high-frequency demodulation signal to the second imaging portion when the low-frequency demodulation signal assumes a voltage associated with the first state.

In some embodiments, the imaging unit further includes a third imaging portion and a fourth imaging portion; wherein the circuitry is further configured to apply the low-frequency demodulation signal to the third imaging portion with a first predefined delay after applying it to the first imaging portion, and apply the high-frequency demodulation signal to the fourth imaging portion with a second predefined delay after applying it to the second imaging portion.

The third imaging portion may be configured similar to the first imaging portion and may be included in a pixel, of the imaging unit, that is adjacent to the pixel that includes the first imaging portion. The fourth imaging portion may be configured similar to the second imaging portion and may be included in a pixel, of the imaging unit, that is adjacent to the pixel that includes the second imaging portion.

The circuitry may provide the low-frequency demodulation signal to the third imaging portion with the first predefined delay after providing it to the first imaging portion. Likewise, the circuitry may provide the high-frequency demodulation signal to the fourth imaging portion with the second predefined delay after providing it to the second imaging portion.

For example, the first predefined delay may correspond to a 90° phase shift of the low-frequency demodulation signal and the second predefined delay may correspond to a 90° phase shift of the high-frequency demodulation signal. For example, the low-frequency demodulation signal and the high-frequency demodulation signal may be provided to the first and the second imaging portion, respectively, as an I signal, and to the third and the fourth imaging portion, respectively, as a Q signal.

In some embodiments, the circuitry is further configured to switch between a first and a second floating diffusion of the second imaging portion according to the applied high-frequency demodulation signal.

The first and the second floating diffusions of the second imaging portion may correspond to a first and a second tap of the second imaging portion, respectively. For example, the second imaging portion may be configured to switch to the first tap when the high-frequency demodulation signal indicates the first state of the high-frequency demodulation signal and switch to the second tap when the high-frequency demodulation signal indicates the second state of the high-frequency demodulation signal. Thus, a tap in which the second imaging portion stores generated charges may depend on a state of the high-frequency demodulation signal.

In some embodiments, when the low-frequency demodulation signal is applied in the second state to the first imaging portion, the high-frequency demodulation signal is applied to the second imaging portion.

For example, the circuitry may apply the low-frequency demodulation signal to the first imaging portion and the high-frequency demodulation signal to the second imaging portion regardless of a state of the low-frequency demodulation signal.

In some embodiments, the circuitry is further configured to switch between a first and a second floating diffusion of the first imaging portion according to the applied low-frequency demodulation signal.

The first and the second floating diffusions of the first imaging portion may correspond to a first and a second tap of the first imaging portion. For example, the first imaging portion may be configured to switch to the first tap when the low-frequency demodulation signal indicates the first state of the low-frequency demodulation signal and switch to the second tap when the low-frequency demodulation signal indicates the second state of the low-frequency demodulation signal. Thus, a tap in which the first imaging portion stores generated charges may depend on a state of the low-frequency demodulation signal.

Thus, a response of the first imaging portion to the low-frequency demodulation signal may be similar to a response of the second imaging portion to the high-frequency demodulation signal.

In some embodiments, when the low-frequency demodulation signal is applied in the second state to the second imaging portion, the high-frequency demodulation signal is applied to the first imaging portion.

For example, the circuitry may apply the high-frequency demodulation signal to the second imaging portion when the low-frequency demodulation signal is applied to the first imaging portion (e.g., in the first state of the low-frequency demodulation signal), and the circuitry may apply the high-frequency demodulation signal to the first imaging portion when the low-frequency demodulation signal is applied to the second imaging portion (e.g., in the second state of the low-frequency demodulation signal).

For example, the circuitry may swap, depending on a state of the low-frequency demodulation signal, which one of the low-frequency demodulation signal and the high-frequency demodulation signal is applied to which one of the first imaging portion and the second imaging portion.

In some embodiments, the first and the second imaging portions each include an overflow gate; and the circuitry is further configured to switch between a first and a second floating diffusion of the first imaging portion according to the applied high-frequency demodulation signal; and activate the overflow gate of the respective first or second imaging portion according to the applied low-frequency demodulation signal.

Applying the low-frequency demodulation signal to the first or second imaging portion may include activating the overflow gate of the respective first or second imaging portion. The overflow gate may be provided between a photoelectric conversion unit and the taps of the respective first or second imaging portion. Activating the overflow gate of the first or of the second imaging portion may include providing a predefined voltage that may be associated with a logical high level to the overflow gate such that the overflow gate may drain electric charges generated by the photoelectric conversion unit and the charges may not be stored in a tap of the respective first or second imaging portion.

Accordingly, depending on a state of the low-frequency demodulation signal, the one of the first and the second imaging portion that is provided with the high-frequency demodulation signal may store generated electric charges in its taps according to a state of the high-frequency demodulation signal, and the one of the first and the second imaging portion that is provided with the low-frequency demodulation signal may not store generated electric charges in its taps but drain the charges through its activated overflow gate.

In some embodiments, the imaging unit further includes a third imaging portion and a fourth imaging portion; and the circuitry is further configured to: apply the low-frequency demodulation signal to the third imaging portion with a first predefined delay after applying it to the first imaging portion, and to the fourth imaging portion with the first predefined delay after applying it to the second imaging portion; and apply the high-frequency demodulation signal to the third imaging portion with a second predefined delay after applying it to the first imaging portion, and to the fourth imaging portion with the second predefined delay after applying it to the second imaging portion.

As mentioned before, the third imaging portion may be configured similar to the first imaging portion and may be included in a pixel, of the imaging unit, that is adjacent to the pixel that includes the first imaging portion. The fourth imaging portion may be configured similar to the second imaging portion and may be included in a pixel, of the imaging unit, that is adjacent to the pixel that includes the second imaging portion.

The circuitry may provide the low-frequency demodulation signal and the high-frequency demodulation signal to the third imaging portion with the respective first or second predefined delay after providing them to the first imaging portion. Likewise, the circuitry may provide the low-frequency demodulation signal and the high-frequency demodulation signal to the fourth imaging portion with the respective first or second predefined delay after providing them to the second imaging portion.

In some embodiments, the second predefined delay corresponds to a 90° phase shift of the high-frequency demodulation signal.

Thus, the circuitry may apply the high-frequency demodulation signal to the first (or second) imaging portion as an I signal and to the third (or fourth, respectively) imaging portion as a Q signal.

In some embodiments, the first predefined delay corresponds to a 90° phase shift of the low-frequency demodulation signal.

Thus, the circuitry may apply the low-frequency demodulation signal to the first (or second) imaging portion as an I signal and to the third (or fourth, respectively) imaging portion as a Q signal.

In some embodiments, the first predefined delay corresponds to an integer multiple of a half period of the high-frequency demodulation signal.

For example, the first predefined delay may be chosen such that a change between the first and the second state of the delayed low-frequency demodulation signal coincides with a change between the first and the second state of the (delayed and/or not delayed) high-frequency demodulation signal in cases with a suitable frequency ratio between the low-frequency demodulation signal and the high-frequency demodulation signal.

In some embodiments, the first predefined delay deviates from a 90° phase shift of the low-frequency demodulation signal by a 90° phase shift of the high-frequency demodulation signal.

For example, for determining the first predefined delay, a duration that corresponds to a 90° phase shift of the high-frequency demodulation signal may be added to or subtracted from a duration that corresponds to a 90° phase shift of the low-frequency demodulation signal, and the resulting duration may be used as the first predefined delay.

Thus, the first predefined delay may be chosen such that a change between the first and the second state of the delayed low-frequency demodulation signal coincides with a change between the first and the second state delayed high-frequency demodulation signal in cases with a suitable frequency ratio between the low-frequency demodulation signal and the high-frequency demodulation signal, e.g., in cases where a frequency of the high-frequency demodulation signal is an integer multiple of a frequency of the low-frequency demodulation signal.

Although the Q signal for the low-frequency demodulation signal may have a deviation from a 90° phase shift of the low-frequency demodulation signal, the circuitry may determine, based on the Q signal for the low-frequency demodulation signal, a phase shift of the reflected signal from the scene with respect to the emitted modulated illumination signal with a precision that allows determining the correct number of periods of the high-frequency demodulation signal.

In some embodiments, a frequency of the high-frequency demodulation signal is an integer multiple of a frequency of the low-frequency demodulation signal.

For example, a period of the low-frequency demodulation signal may correspond to an integer number of periods of the high-frequency demodulation signal. Thus, the low-frequency demodulation signal and the high-frequency demodulation signal may be aligned such that each change between the first and the second state of the low-frequency demodulation signal coincides with a change between the first and the second state of the high-frequency demodulation signal.

In some embodiments, a frequency of the high-frequency demodulation signal is an odd multiple of two times a frequency of the low-frequency demodulation signal.

For example, a frequency ratio between the low-frequency demodulation signal and the high-frequency demodulation signal may be 1:6 or 1:10 or 1:14 such that three or five or seven light pulses, respectively, of the emitted modulated illumination signal may occur between two consecutive changes between the first and the second state of the low-frequency demodulation signal. However, the disclosure is not limited to these numbers, and other frequency ratios or numbers of light pulses may as well be realized.

An odd number of light pulses of the emitted modulated illumination signal (which may correspond to the high-frequency demodulation signal) between two consecutive state changes of the low-frequency demodulation signal may allow a continuous low frequency phase estimation (although a certain systematic cycle error may occur in some embodiments) despite a discrete illumination signal (as the emitted modulated illumination signal may be interrupted at a rate that may correspond to the high-frequency demodulation signal).

In some embodiments, the circuitry is further configured to generate depth data based on the first and the second imaging portions in a single shot.

The generating of depth data in a single shot may include keeping properties (e.g., frequency, phase and duty cycle) of the modulation signal and of the low-frequency and high-frequency demodulation signals constant during an integration time (a time needed to collect a sufficient number of charges in the floating diffusions) followed by a single data read out operation of all imaging portions. Thus, the generating of depth data in a single shot may be different from other uses of the term “single shot” in some instances, where several consecutive integrations may be performed with different properties of (de)modulation signals in each acquisition, followed by a single or by multiple data read out operations, which some instances may still name “single shot” operation as a single depth data instance may be obtained within a relatively short time. However, according to the present disclosure, the term “single shot” may refer to generating a depth data instance based on a single data read out operation from the floating diffusions, wherein the properties of the modulation signal and of the low-frequency and high-frequency demodulation signals are not changed before the data read out operation.

For example, the circuitry may cause the first to fourth imaging portions to store charges generated by photoelectric conversion in their respective taps according to the applied low-frequency and/or high-frequency demodulation signals for a predefined number of periods of the low-frequency or high-frequency demodulation signal. The circuitry may then obtain the ratios of charges stored in the taps of the respective first to fourth imaging portions and determine a distance based on the obtained ratios of charges. The determined distance may indicate a depth of the scene and, thus, may correspond to the depth data.

Some embodiments pertain to a ToF image sensor circuitry control method for controlling a ToF image sensor circuitry that includes an imaging unit with a first imaging portion and a second imaging portion, wherein the method further includes applying a low-frequency demodulation signal that has a first state and a second state, and applying a high-frequency demodulation signal, wherein, when the low-frequency demodulation signal is applied in the first state to the first imaging portion, the high-frequency demodulation signal is applied to the second imaging portion.

The ToF image sensor circuitry controlled by the ToF image sensor circuitry control method may have any configuration corresponding to a configuration described above for a ToF image sensor circuitry. Furthermore, the ToF image sensor circuitry control method may be configured corresponding to the ToF image sensor circuitry described above and may have features that correspond to the features described above with respect to a ToF image sensor circuitry.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Accordingly, in some embodiments, phase information of reflected light can be measured on both, high and low modulation frequencies, simultaneously in a single exposure based on utilizing a special modulation pattern of a time-of-flight (ToF) illumination signal. The special modulation pattern of the ToF illumination signal corresponds in some embodiments to a convolution of high- and low-frequency modulation signals. For example, in a case where the low-frequency demodulation signal has a duty cycle of 50%, during a first half of a period of the low-frequency modulation signal, light pulses may be emitted according to the high-frequency modulation signal, and no light may be emitted during a second half of the period of the low-frequency modulation signal. However, the modulation signal may be configured different as well. For example, the low-frequency demodulation signal may change between the first and the second state at another time than when a half period of the low-frequency modulation signal has elapsed (e.g., the low-frequency modulation signal may have a duty cycle other than 50%) For example, a number of high-frequency modulation pulses may be different between consecutive repletion periods of the low-frequency demodulation signal. For example, the low-frequency demodulation signal and/or the high-frequency demodulation signal may have an arbitrary waveform that may be not similar to block-wave derivatives. In some embodiments, signal energy is concentrated in the illumination modulation signal in two frequency harmonics corresponding to demodulation frequencies of the low-frequency demodulation signal and of the high-frequency demodulation signal, respectively.

For the phase measurement, four driving signals may be used: 0° and 90° phases (I and Q signals) of the high-frequency modulation signal, and 0° and 90° phases (I and Q signals) of the low-frequency modulation signal, each one for a corresponding imaging portion (e.g., for a corresponding pixel). In some embodiments, the corresponding pixels are spatially interleaved in a way that de-mosaic is possible.

Based on phase information obtained from I and Q (0° and 90° phases) signals of the low-frequency modulation signal, a rough depth may be determined, which may be used to de-alias phase information obtained from I and Q (0° and 90° phases) signals of the high-frequency modulation signal. Thus, a distance to an object in a scene may be derived within an unambiguous range that corresponds to the low-frequency modulation signal while a depth noise may correspond to the high-frequency modulation signal.

Returning to FIG. 1, FIG. 1 illustrates an overview of a ToF image sensor circuitry 1 according to an embodiment. The circuitry 1 includes a control unit 2, a storage unit 3, a communication unit 4, an illumination unit 5, an imaging unit 6 and a lens 7.

The control unit 2 includes a microprocessor and controls an overall functionality of the circuitry 1. The control unit 2 performs data processing, which includes generating depth data.

The storage unit 3 includes an EEPROM storage and has stored software instructions for the control unit 2.

The communication unit 4 includes a CSI and transmits depth data generated by the control unit 2 to an external device that is connected to the CSI.

The illumination unit 5 includes a VCSEL array and emits an illumination signal according to a modulation signal from the control unit 2. The illumination signal includes sequences of infrared light pulses. More details of the illumination signal are provided below with respect to FIG. 4 to 9.

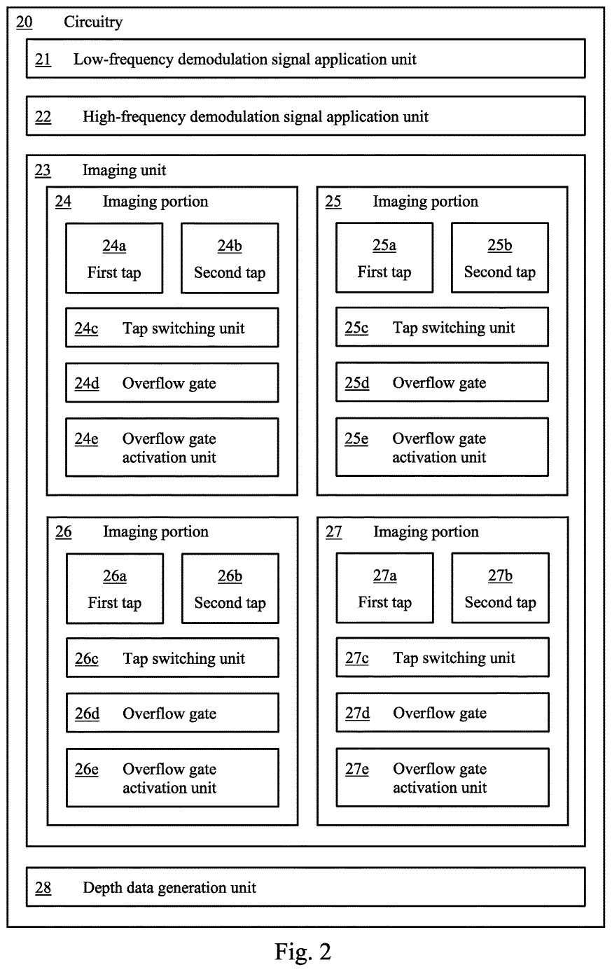

The imaging unit 6 includes a two-dimensional array of pixels. The pixels of the array are examples of photosensitive elements and include pixels 6a to 6d. Example configurations of the pixels 6a to 6d are described below with respect to FIG. 2 to 9.

The lens 7 focuses incident light on the pixels (including pixels 6a to 6d) of the imaging unit 6.

For generating depth data of a scene 8, the control unit 2 generates a modulation signal to the illumination unit 5. The illumination unit 5 generates a modulated illumination signal 9 according to the modulation signal from the control unit 2 and emits the modulated illumination signal 9 into the scene 8. The modulated illumination signal 9 is reflected by objects in the scene. A reflected signal 10, which corresponds to the reflection of the modulated illumination signal 9 by the objects, incides on the lens 7 and is focused on the pixels 6a to 6d of the imaging unit 6. The pixels 6a to 6d perform photoelectric conversion of the incident light of the reflected signal 10 and store photoelectric charges generated by the photoelectric conversion in taps, as described in more detail below with respect to FIG. 2 to 9. The control unit 2 obtains ratios of charges stored in the taps of the pixels 6a to 6d and determines the depth data of the scene 8 based on the ratios of charges.

It is noted that, although FIG. 1 shows a two-dimensional array of pixels, the imaging unit 6 includes in some embodiments a one-dimensional array of pixels (e.g., a single row or column of pixels) or a single pixel only. In the latter case, the lens 7 may be omitted. Further, in some embodiments, the communication unit 4 transmits the depth data based on any other suitable technology instead of CSI or writes the depth data to a storage medium. In some embodiments, the communication unit 4 transmits, instead of the depth data, processed data which the control unit 2 has obtained by processing the depth data. For example, the processed data may include an indication of an object recognized in the scene and/or a size or geometry of the object.

FIG. 2 illustrates a ToF image sensor circuitry 20 in more detail according to an embodiment. The circuitry 20 includes a low-frequency demodulation signal application unit 21, a high-frequency demodulation signal application unit 22, an imaging unit 23 with imaging portions 24 to 27 and a depth data generation unit 28.

The low-frequency demodulation signal application unit 21 applies a low-frequency demodulation signal to the imaging portions 24 to 27. The high-frequency demodulation signal application unit 22 applies a high-frequency demodulation signal to the imaging portions 24 to 27. Both the low-frequency demodulation signal and the high-frequency demodulation signal include state changes at a duty rate of 50%, wherein a modulation frequency (i.e., state change cycling rate) of the high-frequency demodulation signal is higher than a modulation frequency of the low-frequency demodulation signal. In the case described herein, the modulation frequency of the high-frequency demodulation signal is an integer multiple of the modulation frequency of the low-frequency demodulation signal. More detailed examples of how the low-frequency demodulation signal application unit 21 and the high-frequency demodulation signal application unit 22 apply the low-frequency demodulation signal and the high-frequency demodulation signal, respectively, to the imaging portions 24 to 27 are described below with respect to FIG. 4 to 9.

The imaging unit 23 is an example of the imaging unit 6 of FIG. 1 and includes the imaging portions 24 to 27. The imaging portions 24 to 27 are examples of the pixels 6a to 6d of FIG. 1.

The imaging portion 24 includes a first tap 24a and a second tap 24b. Thus, an example of the imaging portion 24 is a two-tap pixel. The imaging portion 24 further includes a tap switching unit 24c, an overflow gate 24d and an overflow gate activation unit 24e.

When imaging incident light (e.g., the reflected signal 10 of FIG. 1), the imaging portion 24 stores photoelectric charges generated from the incident light by photoelectric conversion in the first tap 24a and the second tap 24b. The tap switching unit 24c switches between the first tap 24a and the second tap 24b for storing the photoelectric charges according to the low-frequency demodulation signal applied by the low-frequency demodulation signal application unit 21 and according to the high-frequency demodulation signal applied by the high-frequency demodulation signal application unit 22.

The overflow gate 24d includes a transistor and can be activated. When activated, the overflow gate 24d connects an input node of the first tap 24a and of the second tap 24b with a power source such that photoelectric charges are drained and are not stored in the first tap 24a or in the second tap 24b.

The overflow gate activation unit 24e activates the overflow gate 24d in accordance with the low-frequency demodulation signal applied by the low-frequency demodulation signal application unit 21.

The imaging portions 25 to 27 are configured similar to the imaging portion 24 and, thus, are not described separately.

Exemplary patterns of applying the low-frequency demodulation signal and the high-frequency demodulation signal to the imaging portions 24 to 27, switching between the respective first taps 24a, 25a, 26a and 27a and the second taps 24b, 25b, 26b and 27b of the imaging portions 24 to 27 and activating the overflow gates 24d, 25d, 26d, 27d of the imaging portions 24 to 27 are described below with respect to FIG. 4 to 9.

The depth data generation unit 28 generates depth data based on the electric charges stored in the respective first taps 24a, 25a, 26a and 27a and the second taps 24b, 25b, 26b and 27b of the imaging portions 24 to 27. The generation of the depth data includes determining ratios of the electric charges stored in the respective first taps 24a, 25a, 26a and 27a and second taps 24b, 25b, 26b and 27b of the imaging portions 24 to 27, performing a de-mosaic algorithm for determining, based on the determined charge ratios, a phase shift of a reflected signal (e.g., of the reflected signal 10 of FIG. 1) with respect to a modulation signal of an emitted modulated illumination signal (e.g., the modulated illumination signal 9 of FIG. 1) and determining the depth based on the determined phase shift.

It is noted that the low-frequency-demodulation signal application unit 21, the high-frequency demodulation signal application unit 22 and the depth data generation unit 28 may be included in the control unit 2 of FIG. 1. It is further noted that, in some embodiments, the imaging portions 24 to 27 do not include the overflow gates 24d, 25d, 26d and 27d and the overflow gate activation units 24e, 25e, 26e and 27e, and that, in some embodiments, some imaging portions (e.g., the imaging portions 26 and 27) include the overflow gates 26d and 27d and the overflow gate activation units 26e and 27e while some imaging portions (e.g., the imaging portions 24 and 25) do not include the overflow gates 24d and 25d and the overflow gate activation units 24e and 25e. It is also noted that, in some embodiments, the imaging portions 24 and 26 are included in a same pixel, and the imaging portions 25 and 27 are included in a same pixel (four-tap pixel).

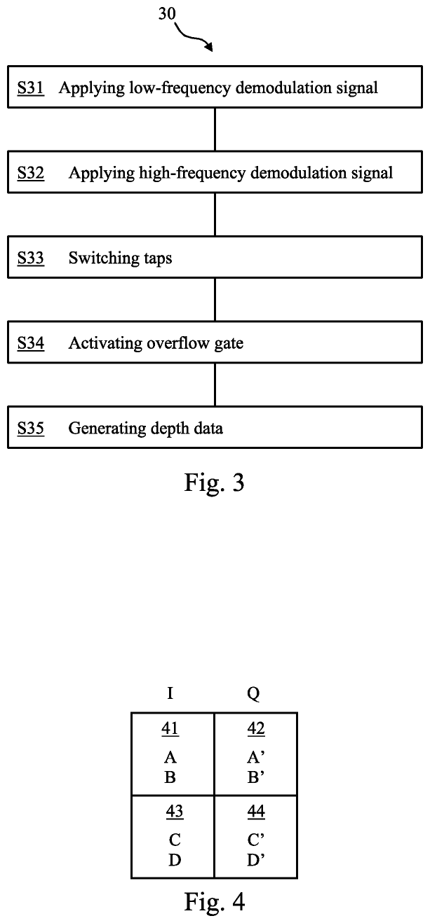

FIG. 3 illustrates a ToF image sensor circuitry control method 30 according to an embodiment. The method 30 is an example of a method that is performed by the circuitry 1 of FIG. 1 or by the circuitry 20 of FIG. 2.

At S31, the low-frequency demodulation signal application unit 21 of FIG. 2 applies a low-frequency demodulation signal to the imaging portions 24 to 27 of FIG. 2.

At S32, the high-frequency demodulation signal application unit 22 of FIG. 2 applies a high-frequency demodulation signal of the imaging portions 24 to 27 of FIG. 2.

At S33, the tap switching units of the imaging portions 24 to 27 switch between respective first taps 24a, 25a, 26a and 27a and second taps 24b, 25b, 26b and 27b of the imaging portions 24 to 27 for storing photoelectric charges according to the applied low-frequency demodulation signal and high-frequency demodulation signal applied at S31 and S32, respectively.

At S34, the overflow gate activation units 24e, 25e, 26e and 27e of the imaging portions 24 to 27 activate the overflow gates 24d, 25d, 26d and 27d of the imaging portions 24 to 27 according to the low-frequency demodulation signal applied at S31.

At S35, the depth data generation unit 28 of FIG. 2 generates depth data based on electric charges stored in the first taps 24a, 25a, 26a and 27a and second taps 24b, 25b, 26b and 27b of the imaging portions 24 to 27.

It is noted that S31 to S34 of the method 30 are performed in any suitable order and/or are applied simultaneously to a same imaging portion 24 to 27 and/or to different imaging portions 24 to 27. It is further noted that the activating of the overflow gates 24d, 25d, 26d and 27d at S34 is omitted in some embodiments, e.g., where the overflow gates 24d, 25d, 26d and 27d and the overflow gate activation units 24e, 25e, 26e and 27e of FIG. 2 are omitted.

Detailed examples of the method 30 are described below with respect to FIG. 4 to 9.

FIG. 4 illustrates four two-tap pixels 41 to 44 according to an embodiment. The four two-tap pixels 41 to 44 are examples of the pixels 6a to 6d of FIG. 1 and for the imaging portions 24 to 27 of FIG. 2.

Taps of the pixel 41 are labeled as A and B and are examples of the first tap 24a and the second tap 24b of the imaging portion 24 of FIG. 2, respectively. Taps of the pixel 42 are labeled as A′ and B′ and are examples of the first tap 25a and the second tap 25b of the imaging portion 25 of FIG. 2. Taps of the pixel 43 are labeled as C and D and are examples of the first tap 26a and the second tap 26b of the imaging portion 26 of FIG. 2, respectively. Taps of the pixel 44 are labeled as C′ and D′ and are examples of the first tap 27a and the second tap 27b of the imaging portion 27 of FIG. 2, respectively.

The low-frequency demodulation signal application unit 21 of FIG. 2 applies a low-frequency demodulation signal to the pixels 41 to 44 at S31 of FIG. 3, and the high-frequency demodulation signal application unit 22 of FIG. 2 applies a high-frequency demodulation signal to the pixels 41 to 44 at S32 of FIG. 3. The pixels 41 and 43 in a left column receive an I signal, i.e., low-frequency and high-frequency demodulation signal application units 21 and 22 apply the low-frequency and high-frequency demodulation signals, respectively, to the pixels 41 and 43 without adding a delay with respect to a modulation signal for a illumination signal (e.g., the illumination signal 9 of FIG. 1). The pixels 42 and 44 in a right column receive a Q signal, i.e., the low-frequency and high-frequency demodulation signal application units 21 and 22 apply the low-frequency and high-frequency demodulation signals, respectively, to the pixels 42 and 44 with a delay with respect to the modulation signal for the illumination signal (e.g., the illumination signal 9 of FIG. 1).

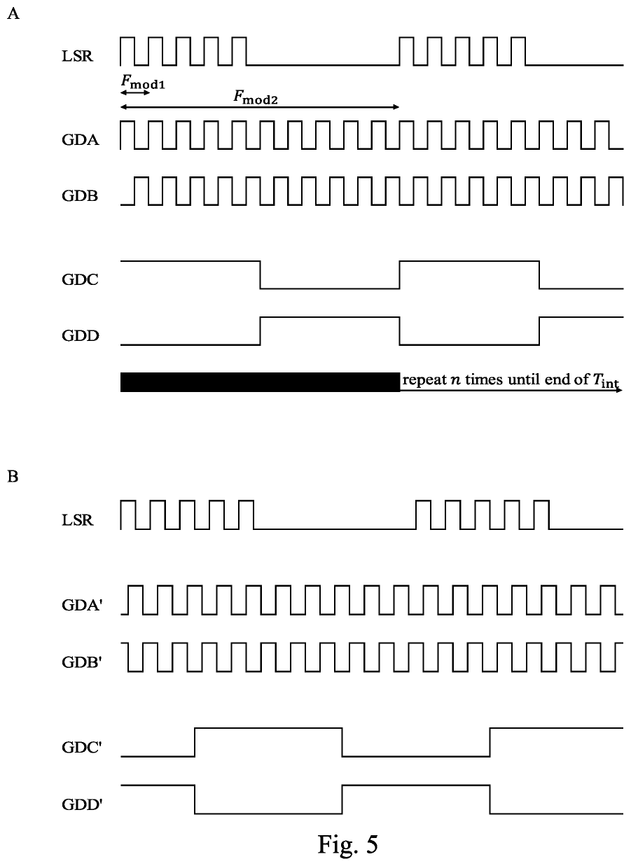

Timing diagrams for applying the high-frequency demodulation signal and the low-frequency demodulation signal to the pixels 41 to 44 are described below with respect to FIG. 5 to 7.

Note that, although the I signal is applied to the pixels 41 and 43 in the left column and the Q signal is applied to the pixels 42 and 44 in the right column in the embodiment of FIG. 4, the I signal is in some embodiments applied to the pixels 42 and 44 in the right column and the Q signal is applied to the pixels 41 and 43 in the left column. Further, in some embodiments, a first one of the I signal and the Q signal is applied to the pixels 41 and 42 in an upper row, and a second one of the I signal and the Q signal is applied to the pixels 43 and 44 in a lower row. Further, in some embodiments, the I signal and the Q signal are applied diagonally, i.e., a first one of the I signal and the Q signal is applied to the pixels 41 and 44, and a second one of the I signal and the Q signal is applied to the pixels 42 and 43.

FIG. 5 illustrates a timing diagram in which a high-frequency demodulation signal is applied to the two two-tap pixels 41 and 42 of FIG. 4 and a low-frequency demodulation signal is applied to the two two-tap pixels 43 and 44 of FIG. 4 according to an embodiment. That is, the high-frequency demodulation signal application unit 22 of FIG. 2 applies the high-frequency demodulation signal to the pixels 41 and 42 in the upper row of FIG. 4 at S32 of FIG. 3 both in a first and in a second state of the low-frequency demodulation signal, and the low-frequency demodulation signal application unit 21 of FIG. 2 applies the low-frequency demodulation signal to the pixels 43 and 44 in the lower row of FIG. 4 at S31 of FIG. 3 both in the first and in the second state of the low-frequency demodulation signal.

A of FIG. 5 shows a waveform LSR of an emitted modulated illumination signal (e.g., the modulated illumination signal 9 of FIG. 1). The waveform LSR includes five subsequent light pulses emitted according to a modulation frequency of a modulation signal at a duty cycle of 50%. After the five subsequent light pulses, LSR remains at a logical low level for five further periods of the modulation signal. Then, further five subsequent light pulses follow, and so on.

A of FIG. 5 further shows an on-off state GDA of the tap A of the pixel 41 and an on-off state GDB of the tap B of the pixel 41. At S33 of FIG. 3, a tap switching unit of the pixel 41 (e.g., the tap switching unit 24c of FIG. 2) switches to the tap A in a first state of the high-frequency demodulation signal and to the tap B in a second state of the high-frequency demodulation signal. The high-frequency demodulation signal alternately assumes its first and its second state with a period F_{mod1} and a duty cycle of 50%. The period F_{mod1} corresponds to the pulses of the waveform LSR, and the high-frequency demodulation signal is aligned with the waveform LSR.

A of FIG. 5 further shows an on-off state GDC of the tap C of the pixel 43 and an on-off state GDD of the tap D of the pixel 43. At S33 of FIG. 3, a tap switching unit of the pixel 43 (e.g., the tap switching unit 26c of FIG. 2) switches to the tap C in a first state of the low-frequency demodulation signal and to the tap D in a second state of the low-frequency demodulation signal. The low-frequency demodulation signal alternately assumes its first and its second state with a period F_{mod2} and a duty cycle of 50%. The period F_{mod2} is ten times as long as the period F_{mod1}. Thus, a frequency ratio between the low-frequency demodulation signal and the high-frequency demodulation signal is 1:10. The low-frequency demodulation signal is aligned with the high-frequency demodulation signal. The low-frequency demodulation signal is further aligned with the waveform LSR such that the pulses of LSR are included in the first state of the low-frequency demodulation signal.

The low-frequency and the high-frequency demodulation signals are applied to the respective taps A, B, C and D as an I signal, i.e., with 0° phase shift.

B of FIG. 5 again shows the waveform LSR.

B of FIG. 5 further shows an on-off state GDA′ of the tap A′ of the pixel 42 and an on-off state GDB′ of the tap B′ of the pixel 42. At S32 of FIG. 3, the high-frequency demodulation signal application unit 22 applies the high-frequency demodulation signal with a predefined delay to the pixel 42 as a Q signal after applying the high-frequency demodulation signal to the pixel 41. Thus, the delay corresponds to a 90° phase shift of the high-frequency demodulation signal. Accordingly, at S33, a tap switching unit of the pixel 42 (e.g., the tap switching unit 25c) switches to the taps A′ and B′ with the 90° phase shift delay after the tap switching unit of the pixel 41 switches to the taps A and B, respectively.

B of FIG. 5 further shows an on-off state GDC′ of the tap C′ of the pixel 44 and an on-off state GDD′ of the tap D′ of the pixel 42. At S31 of FIG. 3, the low-frequency demodulation signal application unit 21 applies the low-frequency demodulation signal with a predefined delay to the pixel 44 as a Q signal after applying the high-frequency demodulation signal to the pixel 43. Thus, the delay corresponds to a 90° phase shift of the low-frequency demodulation signal. Accordingly, at S33, a tap switching unit of the pixel 44 (e.g., the tap switching unit 27c) switches to the taps C′ and D′ with the 90° phase shift delay after the tap switching unit of the pixel 43 switches to the taps C and D, respectively.

A black bar at the bottom of A of FIG. 5 illustrates one period of LSR. The waveform LSR as well as the high-frequency and the low-frequency demodulation signals are repeated for n periods (i.e., n times, where n is an integer) of LSR until an integration time Tint ends. After Tint has elapsed, the charges accumulated in the taps A, A′, B, B′, C, C′, D and D′ are read out, and, at S35 of FIG. 3, the depth data generation unit 28 generates depth data based on charge ratios between the taps of the respective pixels 41 to 44.

Note that in the embodiment of FIG. 5, the overflow gates 24d, 25d, 26d and 27d as well as the overflow gate activation units 24e, 25e, 26e and 27e of FIG. 2 are not needed and may be omitted. Also, the activation of an overflow gate at S34 of FIG. 3 is not performed in the embodiment of FIG. 5, and the overflow gates 24d, 25d, 26d and 27d are not activated.

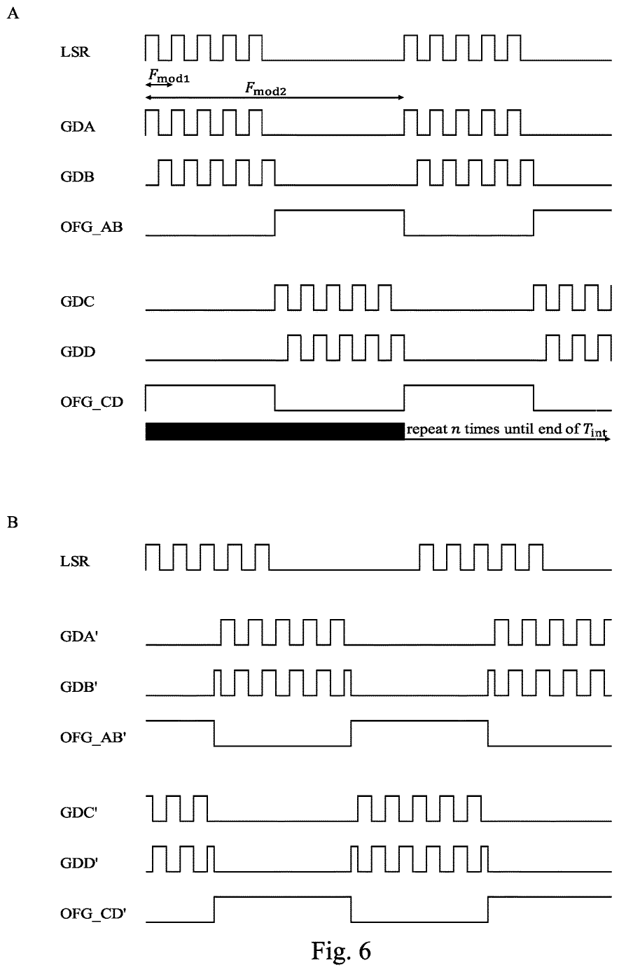

FIG. 6 illustrates a timing diagram in which the high-frequency demodulation signal and the low-frequency demodulation signal are both applied to the four two-tap pixels 41 to 44, wherein a phase shift of the Q signal for the low-frequency demodulation signal corresponds to a 90° phase shift, according to an embodiment. That is, at S32 of FIG. 3, the high-frequency demodulation signal application unit 22 of FIG. 2 applies the high-frequency demodulation signal in a first state of the low-frequency demodulation signal to the pixels 41 and 42 in the upper row of FIG. 4 and in a second state of the low-frequency demodulation signal to the pixels 43 and 44 in the lower row of FIG. 4, and, at S31 of FIG. 3, the low-frequency demodulation signal application unit 21 of FIG. 2 applies the low-frequency demodulation signal in the first state of the low-frequency demodulation signal to the pixels 43 and 44 in the lower row of FIG. 4 and in the second state of the low-frequency demodulation signal to the pixels 41 and 42 in the upper row of FIG. 4.

Thus, the embodiment of FIG. 6 differs from the embodiment of FIG. 5 in that the low-frequency and the high-frequency demodulation signals are applied to all four pixels 41 to 44 according to a state of the low-frequency demodulation signal.

Additionally, in the embodiment of FIG. 6, when the low-frequency demodulation signal is applied to a pixel 41 to 44, the tap switching unit of the respective pixel does not switch between the respective taps as in the embodiment of FIG. 5, but an overflow gate activation unit of the respective pixel (e.g., the overflow gate activation unit 24e, 25e, 26e or 27e of FIG. 2) activates an overflow gate (e.g., the overflow gate 24d, 25d, 26d or 27d of FIG. 2) of the respective pixel such that photoelectric charges are drained and are not accumulated in the taps of the respective pixel 41 to 44. The overflow gates of the pixels 41 to 44 are configured as Fast overflow gates (Fast OFGs), i.e., they are fast enough for being activated and deactivated according to the low-frequency demodulation signal without significantly impacting a charge accumulation in the taps due to slow on-off behavior.

Accordingly, A of FIG. 6 shows an activation state OFG_AB of an overflow gate of the pixel 41. When the low-frequency demodulation signal is applied to the pixel 41, the overflow gate of the pixel 41 is activated such that an accumulation of photoelectric charges in the taps A and B is prevented. Likewise, A of FIG. 6 shows an activation state OFG_CD of the pixel 43. When the low-frequency demodulation signal is applied to the pixel 43, the overflow gate of the pixel 43 is activated such that an accumulation of photoelectric charges in the taps C and D is prevented.

Further, B of FIG. 6 shows an activation state OFG_AB′ of an overflow gate of the pixel 42. When the low-frequency demodulation signal is applied to the pixel 42, the overflow gate of the pixel 42 is activated such that an accumulation of photoelectric charges in the taps A′ and B′ is prevented. Likewise, B of FIG. 6 shows an activation state OFG_CD′ of the pixel 44. When the low-frequency demodulation signal is applied to the pixel 44, the overflow gate of the pixel 44 is activated such that an accumulation of photoelectric charges in the taps C′ and D′ is prevented.

In the embodiment of FIG. 6, the high-frequency demodulation signal is applied to the pixels 42 and 44 as a Q signal with a 90° phase shift. Therefore, the first and last periods after and before activating the overflow gates of the respective pixels 42 and 44 are cropped and the taps B′ and D′ accumulate charges for durations of a half pulse of LSR.

In the embodiment of FIG. 6, the taps A, B, A′ and B′ of the pixels 41 and 42 in the upper row of FIG. 4 accumulate photoelectric charges in a first half period of the low-frequency demodulation signal, and the taps C, D, C′ and D′ of the pixels 43 and 44 in the lower row of FIG. 4 accumulate photoelectric charges in a second half period of the low-frequency demodulation signal.

In some embodiments, the timing of FIG. 5 does not have an impact on the low-frequency modulation signal due to the discrete nature of the modulated illumination signal, however, an accuracy may be impacted by a mismatch of pixel characteristics. Further, in some embodiments, the complementary 90° phase shifted high-frequency modulation signals GDB′ and GDD′ are uneven and may introduce a measurement error if the pixels are frequency bandwidth limited.

Note regarding a functionality of the overflow gate (OFG) signals OFG_AB, OFG_CD, OFG_AB′ and OFG_CD′: When an OFG signal is “logical low”, the respective two-tap pixel operates as usual; photoelectric charges are collected in their corresponding taps (e.g., A and B for the OFG_AB signal). When the OFG signal is “logical high”, the photoelectric charges are drawn away and do not contribute to an accumulated signal in the corresponding taps.

The I signals and the Q signals can be reconstructed as follows:

$${I}_{h i g h} = ( G D A - G D B ) + ( G D C - G DD )$$

$${Q}_{h i g h} = ( {GDA}^{′} - {GDB}^{′} ) + ( {GDC}^{′} - {GDD}^{′} )$$

$${I}_{low} = ( G D A + G D B ) - ( G D C + G D D )$$

$${Q}_{low} = ( {GDA}^{′} + {GDB}^{′} ) - ( {GDC}^{′} + {GDD}^{′} )$$

Here, I_{high} and Q_{high} correspond to the I signal and the Q signal, respectively, of the high-frequency demodulation signal, and I_{low} and Q_{low} correspond to the I signal and the Q signal, respectively, of the low-frequency demodulation signal.

Apart from the aspects discussed above, the embodiment of FIG. 6 corresponds to the embodiment of FIG. 5.

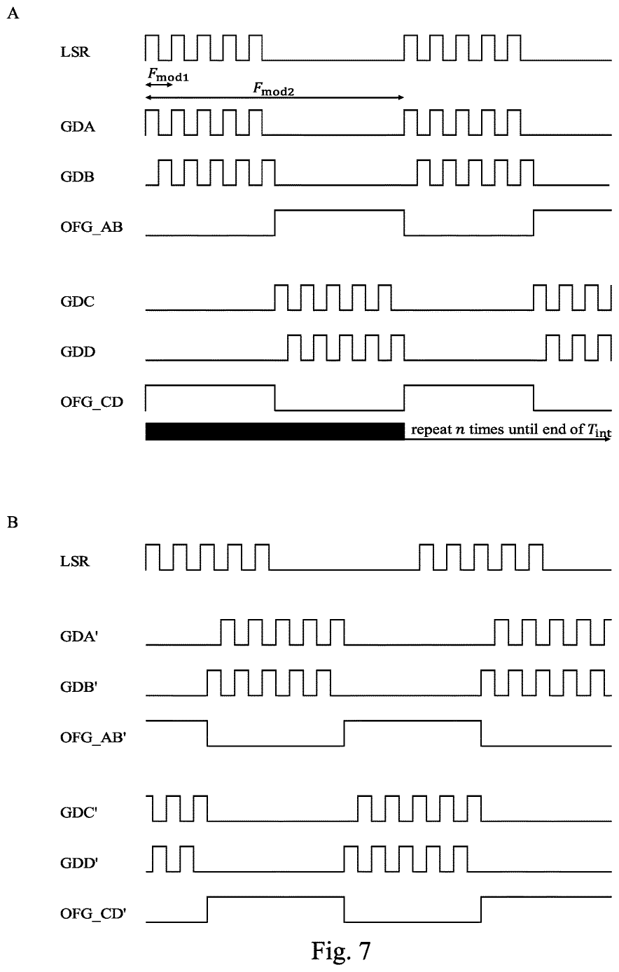

FIG. 7 illustrates a timing diagram in which a high-frequency demodulation signal and a low-frequency demodulation signal are both applied to the four two-tap pixels 41 to 44 of FIG. 4, wherein a phase shift of a Q signal for the low-frequency demodulation signal deviates from a 90° phase shift, according to an embodiment.

The embodiment of FIG. 7 differs from the embodiment of FIG. 6 in that, at S31, the low-frequency demodulation signal application unit 21 applies the low-frequency demodulation signal to the pixels 42 and 44 as a Q signal with a delay that deviates from a 90° phase shift of the low-frequency demodulation signal by an amount that corresponds to a 90° phase shift of the high-frequency demodulation signal. In the embodiment of FIG. 7, the delay corresponds to a 90° phase shift of the low-frequency demodulation signal minus a 90° phase shift of the high-frequency demodulation signal. The delay of the low-frequency demodulation signal may be determined as

$$90 ° - \frac{1}{4} \cdot \frac{360 °}{{f}_{m od \_ ratio}} ,$$

where f_{mod_ratio} corresponds to a frequency ratio between the high-frequency demodulation signal and the low-frequency demodulation signal.

In some embodiments, as described above with respect to FIG. 6, a base method with a Fast OFG (e.g., with an OFG that is sufficiently fast for being activated and deactivated according to the high-frequency demodulation signal) corrupts a complementary phase of the Q signal for the high-frequency modulation signal, leading to a half modulation pulse width, which may cause errors. Another method to address this issue is presented above with respect to FIG. 7, where Q signal pulses always have a same width. In some embodiments, a Fast OFG signal phase is advanced (or delayed) proportionally. Such a phase shift may cause some cycling error in a phase measurement of the low-frequency modulation signal, however, because the phase shift is well known in some embodiments, sufficient compensation may be implemented.

Apart from the aspects discussed above, the embodiment of FIG. 7 corresponds to the embodiment of FIG. 6.

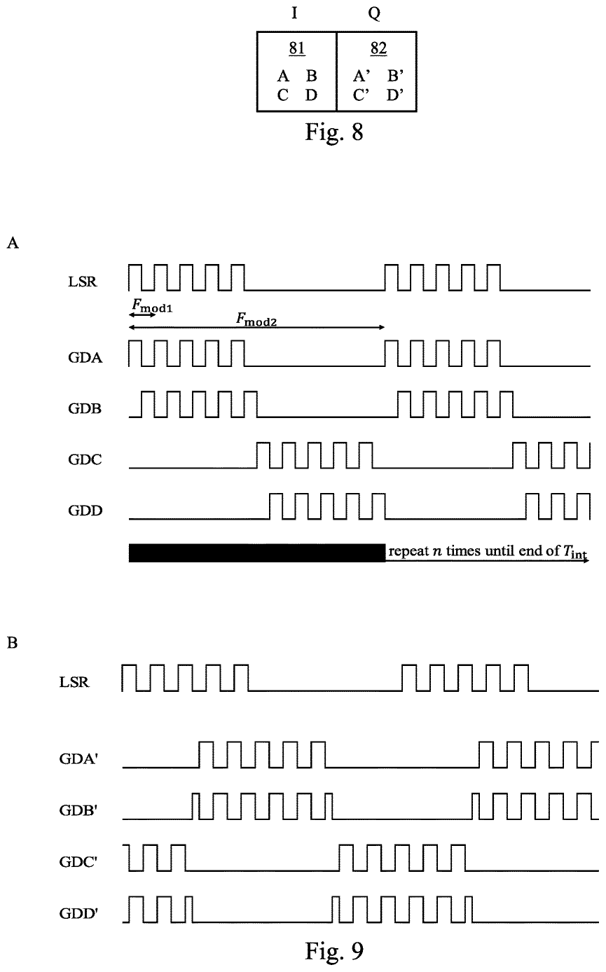

FIG. 8 illustrates two four-tap pixels 81 and 82 according to an embodiment. The two four-tap pixels 41 to 44 are examples of the pixels 6a and 6b as well as 6c and 6d of FIG. 1. The four-tap pixels 81 and 82 are configured similar to the two-tap pixels 41 to 44 of FIG. 4. However, instead of two taps, the pixels 81 and 82 include four taps, which are labeled A, B, C and D for the pixel 81 and A′, B′, C′ and D′ for the pixel 82. For example, the pixel 81 includes both imaging portions 24 and 26 of FIG. 2, and the pixel 82 includes both imaging portions 25 and 27 of FIG. 2. At S31 and S32 of FIG. 3, the low-frequency and high-frequency demodulation signal application units 21 and 22 of FIG. 2 apply the low-frequency and high-frequency demodulation signals, respectively, to the pixel 81 as an I signal and to the pixel 82 as a Q signal.

FIG. 9 illustrates a timing diagram in which the high-frequency demodulation signal is applied to the first four-tap pixel 81 of FIG. 8 and the low-frequency demodulation signal is applied to the second four-tap pixel 82 of FIG. 8 according to an embodiment.

At S31 of FIG. 3, the low-frequency demodulation signal application unit 21 of FIG. 2 applies the low-frequency demodulation signal to the taps C and D as an I signal (with 0° phase shift) and to the taps C′ and D′ as a Q signal (with 90° phase shift) in the first state of the low-frequency demodulation signal, and to the taps A and B as an I signal (with 0° phase shift) and to the taps A′ and B′ as a Q signal (with 90° phase shift) in the second state of the low-frequency demodulation signal.

Likewise, at S32 of FIG. 3, the high-frequency demodulation signal application unit 22 of FIG. 2 applies the high-frequency demodulation signal to the taps A and B as an I signal (with 0° phase shift) and to the taps A′ and B′ as a Q signal (with 90° phase shift) in the first state of the low-frequency demodulation signal, and to the taps C and D as an I signal (with 0° phase shift) and to the taps C′ and D′ as a Q signal (with 90° phase shift) in the second state of the low-frequency demodulation signal.

Thus, at S33 of FIG. 3, tap switching units (e.g., the tap switching units 24c, 25c, 26c and 27c of FIG. 2) of the pixels 81 and 82 switch between the taps A, B, C and D or A′, B′, C′ and C′, respectively, according to the applied low-frequency and high-frequency demodulation signals.

Note that, in the embodiment of FIG. 9, photoelectric charges are accumulated by one tap of each pixel 81 and 82 throughout a whole period of the waveform LSR, such that an overflow gate for draining photoelectric charges is not needed in the pixels 81 to 82. Accordingly, in the embodiment of FIG. 9, overflow gates such as the overflow gates 24d, 25d, 26d and 27d of FIG. 2 as well as overflow gate activation units such as the overflow gate activation units 24e, 25e, 26e and 27e may be omitted, the activation of an overflow gate at S34 of FIG. 3 is not performed and an overflow gate is not activated in the pixels 81 and 82.

Apart from the aspects discussed above, the embodiment of FIG. 9 corresponds to the embodiment of FIG. 6.

In essence, the dual frequency one-shot I/Q mosaic method of FIG. 9 with four-tap pixels is similar to the method with a Fast OFG of FIG. 6, though benefiting from twice more signal and an easier de-mosaic. The same adaptation for the complementary phase of the Q signal for the high-frequency modulation signal as shown in FIG. 7 may be applied to the embodiment of FIG. 9.

In some embodiments, the embodiments of FIGS. 6, 7 and 8 provide a more accurate phase measurement for the low-frequency demodulation signal as compared to the embodiment of FIG. 5.

Thus, some embodiments a dual frequency one-shot I/Q mosaic depth acquisition with i-ToF two-tap pixels provides a high depth precision due to the dual frequency method with minimum motion blur because of a single exposure. Some embodiments achieve this by providing a special modulation pattern based on a high and a low modulation frequency, and a simultaneous use of four different driving signals in the sensor array.

In some embodiments, the high depth precision due to the dual frequency method reduces a power consumption and a motion blur due to using a single exposure and a single data read out. In some embodiments, the present technology is realized with a standard two-tap pixel, thus requiring low added complexity for a pixel array and an illumination circuit as well as placing relaxed requirements on a read-out circuit with low power consumption (which may have a slow analog-to-digital converter (ADC) and interface speed).

In some embodiments, a Fast OFG is used for a low-frequency demodulation signal (which may require a two-tap pixel with a Fast OFG). In some embodiments, a four-tap pixel and I/Q mosaic is used with a special illumination pattern and adapted driving signals.

In the following, examples of application of a ToF image sensor circuitry and/or of a ToF image sensor circuitry control method according to the disclosure are provided.

The technology according to an embodiment of the present disclosure is applicable to various products. For example, the technology according to an embodiment of the present disclosure may be implemented as a device included in a mobile device, e.g., a smartphone, smart glasses, a head-mounted display, a smartwatch, a mobile phone, a mobile tablet, a notebook, a terminal device or the like.

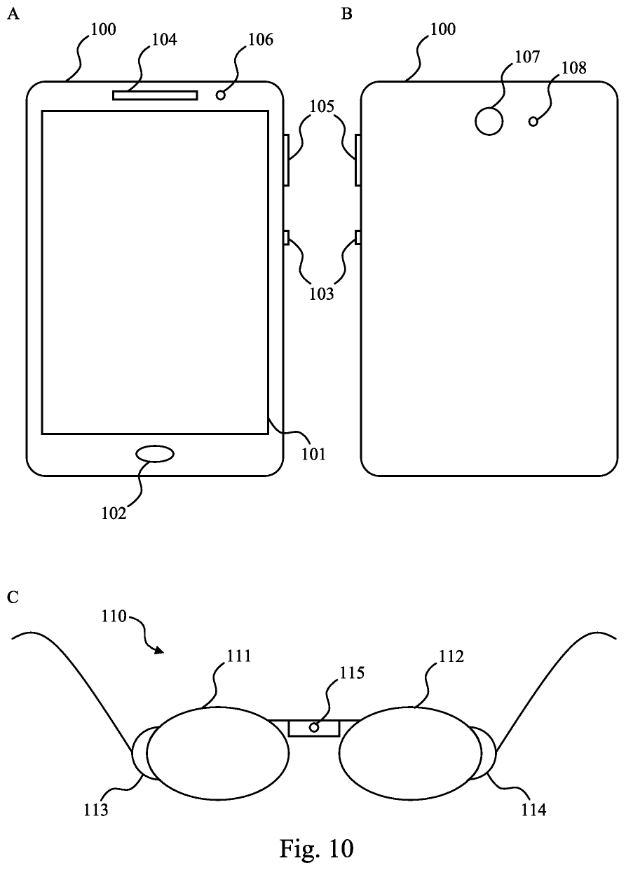

FIG. 10 illustrates an embodiment of a smartphone 100 and of smart glasses 110.

A of FIG. 10 shows a front side of the smartphone 100. The smartphone 100 includes a touchscreen 101, a home button 102, a power button 103, a loudspeaker 104, a volume button 105 and a first imaging sensor 106.

The touchscreen 101 displays visual content to a user and receives touch input from the user. The home button 102 receives an input from the user. By pressing the home button 102, the user can cause a home screen to be displayed on the touchscreen 101. The power button 103 receives an input from the user. By pressing the power button 103 for a short time (e.g., shorter than a second, without limiting the disclosure thereto), the user can cause the touchscreen 101 to be switched on if the touchscreen 101 is off and to be switched off if the touchscreen 101 is on. By pressing the power button 103 for a longer time (e.g., longer than two seconds, without limiting the disclosure thereto), the user can cause the smartphone 100 to be switched on if the smartphone 100 is off and to be switched off if the smartphone 100 is on. The loudspeaker 104 outputs audio content including music and speech to the user. The volume button 105 receives input from the user. By pressing an upper portion of the volume button 105, the user can increase a volume of the sound output by the loudspeaker 104. By pressing a lower portion of the volume button 105, the user can decrease a volume of the sound output by the loudspeaker 104.

The first imaging sensor 106 includes circuitry that is configured like the circuitry 1 of FIG. 1 and like the circuitry 20 of FIG. 2, and performs i-ToF measurements according to the method 30 of FIG. 3. The first imaging sensor 106 detects, based on the i-ToF measurements, whether the user is present in front of the smartphone 100. If the first imaging sensor 106 detects that the presence of the user changes from the user not being present in front of the smartphone 100 to the user being present within a predetermined range in front of the smartphone 100, the first imaging sensor 106 causes the touchscreen 101 to be switched on. The first imaging sensor 106 senses, based on the i-ToF measurements, a three-dimensional (3D) shape of a face of the user and authenticates the user based on the 3D shape of his face. If the first imaging sensor 106 authenticates the user when the touchscreen 101 is displaying a lock screen, the first imaging sensor 106 causes the lock screen to be unlocked. The first imaging sensor 106 detects, based on the i-ToF measurements, an object in close proximity to the front side of the smartphone 100, e.g., if the smartphone 100 is put into a bag or laid down on a table with the front side facing downwards. If the first imaging sensor 106 detects an object in close proximity of the front side of the smartphone 100, the first imaging sensor 106 causes the touchscreen 101 to be switched off for saving electrical energy.

B of FIG. 10 shows a back side of the smartphone 100. The smartphone 100 includes a camera 107 and a second imaging sensor 108.

The camera 107 captures visual content such as photos and movies. The camera 107 has an aperture that is large enough such that the camera 107 receives sufficient light for capturing photos and movies that comply with a desired image quality. The camera 107 further has a lens adjustable by an autofocus function for acquiring a sharp image of an object at one of various distances from the camera 107.

The second imaging sensor 108 includes circuitry that is configured like the circuitry 1 of FIG. 1 and like the circuitry 20 of FIG. 2, and performs i-ToF measurements according to the method 30 of FIG. 3. The second imaging sensor 108 determines, based on the i-ToF measurements, a distance of an object from the camera 107 and provides the determined distance to the autofocus function such that the autofocus function can adjust the lens for acquiring, with the camera 107, a sharp image of the object. The second imaging sensor 108 generates, based on the i-ToF measurements, a 3D map of an environment of the smartphone 100 for a mapping application that generates a map of the environment, for a navigation application that navigates the user through a known environment and for an augmented reality application that controls display of a virtual object on the touchscreen 101, including a size, a position and a perspective of the virtual object as well as an overlap of the virtual object with a real object. The second imaging sensor 108 generates, based on the i-ToF measurements, a 3D representation of an object in the standard tessellation language (STL) format for replicating the object with a 3D printer.

C of FIG. 10 shows smart glasses 110. The smart glasses 110 include a right glass 111, a left glass 112, a right eye-tracking and display unit 113, a left eye-tracking and display unit 114 and an imaging sensor 115.

When a user is wearing the smart glasses 110, the right glass 111 is positioned in front of a right eye of the user such that light incident from an environment into the right eye passes through the right glass 111. Likewise, when the user is wearing the smart glasses 110, the left glass 112 is positioned in front of a left eye of the user such that light incident from the environment into the left eye passes through the left glass 112. The right glass 111 and the left glass 112 each include a waveguide and a holographic optical element (HOE). The waveguide leads, based on total internal reflection, a light signal representing a virtual object to the respective HOE. The HOE extracts, based on Bragg reflection, the light signal from the waveguide and reflects the light signal to the respective right or left eye of the user, thus allowing the user to see the virtual object represented by the light signal.

The right eye-tracking and display unit 113 and the left eye-tracking and display unit 114 each include a microdisplay that generates and emits the respective light signal representing the virtual object and an optical means (e.g., lens, mirror, grating) that couples the light signal into the waveguide of the respective right or left glass 111 or 112. Further, the right eye-tracking and display unit 113 and the left eye-tracking and display unit 114 each include a camera that tracks a line-of-sight of the respective right or left eye of the user wearing the smart glasses 110 for determining a position on the respective right or left glass 111 or 112 where the virtual object should be displayed and for receiving a user input based on a gaze of the user, e.g., based on determining that a menu item displayed as a virtual object is intersected by the line-of-sight of the user.

The imaging sensor 115 includes circuitry that is configured like the circuitry 1 of FIG. 1 and like the circuitry 20 of FIG. 2 and performs i-ToF measurements according to the method 30 of FIG. 3. The imaging sensor 115 generates, based on the i-ToF measurements, a 3D map of an environment of the smart glasses 110 for a mapping application that generates a map of the environment, for a navigation application that navigates the user through a known environment and for an augmented reality application that controls display of a virtual object on the right or left glass 111 or 112 by the right eye-tracking and display unit 113 or the left eye-tracking and display unit 114, respectively, including a size, a position and a perspective of the virtual object as well as an overlap of the virtual object with a real object seen by the user through the right and/or left glass 111 or 112.

By performing i-ToF measurements according to the method 30 of FIG. 3, the first imaging sensor 106, the second imaging sensor 108 and the imaging sensor 115 consume less electrical power than a conventional i-ToF imaging sensor in some instances. Since a size of the smartphone 100 and of the smart glasses 110 limits a size (and, thus, an amount of stored energy) of a battery of the smartphone 100 and of the smart glasses 110, respectively, performing the i-ToF measurements according to the method 30 of FIG. 3 allows operating the smartphone 100 or smart glasses 110, respectively, for a longer time without recharging the battery.

Note that, in some embodiments, the first imaging sensor 106, the second imaging sensor 108 and the imaging sensor 115 of FIG. 10 include a general-purpose computer such as the computer 150 of FIG. 11.

FIG. 11 illustrates an embodiment of a general-purpose computer 150. The computer 150 can be implemented such that it can basically function as any type of mobile device, for example, a smartphone (e.g., the smartphone 100 of FIG. 10), smart glasses (e.g., the smart glasses 110 of FIG. 10), a head-mounted display, a smartwatch, a mobile phone, a mobile tablet, a notebook, a terminal device or the like. The computer has components 151 to 161, which can form a circuitry, such as any one of the circuitry 1 of FIG. 1 and/or the circuitry 20 of FIG. 2, as described herein.

Embodiments which use software, firmware, programs or the like for performing the methods as described herein can be installed on computer 150, which is then configured to be suitable for the concrete embodiment.

The computer 150 has a CPU 151 (Central Processing Unit), which can execute various types of procedures and methods as described herein, for example, in accordance with programs stored in a read-only memory (ROM) 152, stored in a storage 157 and loaded into a random-access memory (RAM) 153, stored on a medium 160 which can be inserted in a respective drive 159, etc.

The CPU 151, the ROM 152 and the RAM 153 are connected with a bus 161, which in turn is connected to an input/output interface 154. The number of CPUs, memories and storages is only exemplary, and the skilled person will appreciate that the computer 150 can be adapted and configured accordingly for meeting specific requirements which arise, when it functions as a base station or as user equipment (end terminal).

At the input/output interface 154, several components are connected: an input 155, an output 156, the storage 157, a communication interface 158 and the drive 159, into which a medium 160 (compact disc, digital video disc, compact flash memory, or the like) can be inserted.

The input 155 can be a pointer device (mouse, graphic table, or the like), a keyboard, a microphone, a camera, a touchscreen, an eye-tracking unit etc.

The output 156 can have a display (liquid crystal display, cathode ray tube display, light emittance diode display, etc.; e.g., included in a touchscreen), loudspeakers, etc.

The storage 157 can have a hard disk, a solid-state drive, a flash drive and the like.

The communication interface 158 can be adapted to communicate, for example, via a local area network (LAN), wireless local area network (WLAN), mobile telecommunications system (GSM, UMTS, LTE, NR etc.), Bluetooth, near-field communication (NFC), infrared, etc.

It should be noted that the description above only pertains to an example configuration of computer 150. Alternative configurations may be implemented with additional or other sensors, storage devices, interfaces or the like. For example, the communication interface 158 may support other radio access technologies than the mentioned UMTS, LTE and NR.

It should be recognized that the embodiments describe methods with an exemplary ordering of method steps. The specific ordering of method steps is however given for illustrative purposes only and should not be construed as binding. Changes of the ordering of method steps may be apparent to the skilled person.

Please note that the division of the circuitry 1 into units 2 to 6 and of the circuitry 20 into units 21 to 28 is only made for illustration purposes and that the present disclosure is not limited to any specific division of functions in specific units. For instance, the circuitry 1 and the circuitry 20 could be implemented, at least partially, by a respective programmed processor, field programmable gate array (FPGA) and the like.

The method 30 of FIG. 3 can also be implemented as a computer program causing a computer and/or a processor, such as the circuitry 1 or the circuitry 20 discussed above, to perform the method, when being carried out on the computer and/or processor. In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) A time-of-flight image sensor circuitry,
   comprising an imaging unit including a first imaging portion and a second imaging portion,
   wherein the circuitry is further configured to:
      apply a low-frequency demodulation signal having a first state and a second state, and
      apply a high-frequency demodulation signal,
   wherein, when the low-frequency demodulation signal is applied in the first state to the first imaging portion, the high-frequency demodulation signal is applied to the second imaging portion.
(2) The time-of-flight image sensor circuitry of (1),
   wherein the imaging unit further includes a third imaging portion and a fourth imaging portion;
   wherein the circuitry is further configured to apply the low-frequency demodulation signal to the third imaging portion with a first predefined delay after applying it to the first imaging portion, and apply the high-frequency demodulation signal to the fourth imaging portion with a second predefined delay after applying it to the second imaging portion.
(3) The time-of-flight image sensor circuitry of (1) or (2), wherein the circuitry is further configured to:
   switch between a first and a second floating diffusion of the second imaging portion according to the applied high-frequency demodulation signal.
(4) The time-of-flight image sensor circuitry of any one of (1) to (3),
   wherein, when the low-frequency demodulation signal is applied in the second state to the first imaging portion, the high-frequency demodulation signal is applied to the second imaging portion.
(5) The time-of-flight image sensor circuitry of (4), wherein the circuitry is further configured to:
   switch between a first and a second floating diffusion of the first imaging portion according to the applied low-frequency demodulation signal.
(6) The time-of-flight image sensor circuitry of any one of (1) to (3),
   wherein, when the low-frequency demodulation signal is applied in the second state to the second imaging portion, the high-frequency demodulation signal is applied to the first imaging portion.
(7) The time-of-flight image sensor circuitry of (6),
   wherein the first and the second imaging portions each include an overflow gate; and
   wherein the circuitry is further configured to:
      switch between a first and a second floating diffusion of the first imaging portion according to the applied high-frequency demodulation signal; and
      activate the overflow gate of the respective first or second imaging portion according to the applied low-frequency demodulation signal.
(8) The time-of-flight image sensor circuitry of (6) or (7),
   wherein the imaging unit further includes a third imaging portion and a fourth imaging portion; and
   wherein the circuitry is further configured to:
      apply the low-frequency demodulation signal to the third imaging portion with a first predefined delay after applying it to the first imaging portion, and to the fourth imaging portion with the first predefined delay after applying it to the second imaging portion; and
      apply the high-frequency demodulation signal to the third imaging portion with a second predefined delay after applying it to the first imaging portion, and to the fourth imaging portion with the second predefined delay after applying it to the second imaging portion.
(9) The time-of-flight image sensor circuitry of (8),
   wherein the second predefined delay corresponds to a 90° phase shift of the high-frequency demodulation signal.
(10) The time-of-flight image sensor circuitry of (8) or (9),
   wherein the first predefined delay corresponds to a 90° phase shift of the low-frequency demodulation signal.
(11) The time-of-flight image sensor circuitry of any one of (8) to (10),
   wherein the first predefined delay corresponds to an integer multiple of a half period of the high-frequency demodulation signal.
(12) The time-of-flight image sensor circuitry of (8) or (9),
   wherein the first predefined delay deviates from a 90° phase shift of the low-frequency demodulation signal by a 90° phase shift of the high-frequency demodulation signal.
(13) The time-of-flight image sensor circuitry of any one of (1) to (12),
   wherein a frequency of the high-frequency demodulation signal is an integer multiple of a frequency of the low-frequency demodulation signal.
(14) The time-of-flight image sensor circuitry of any one of (1) to (13),
   wherein a frequency of the high-frequency demodulation signal is an odd multiple of two times a frequency of the low-frequency demodulation signal.
(15) The time-of-flight image sensor circuitry of any one of (1) to (14),
   further configured to generate depth data based on the first and the second imaging portions in a single shot.
(16) A time-of-flight image sensor circuitry control method for controlling a time-of-flight image sensor circuitry including an imaging unit including a first imaging portion and a second imaging portion,
   wherein the method further comprises:
      applying a low-frequency demodulation signal having a first state and a second state, and
      applying a high-frequency demodulation signal,
   wherein, when the low-frequency demodulation signal is applied in the first state to the first imaging portion, the high-frequency demodulation signal is applied to the second imaging portion.
(17) The time-of-flight image sensor circuitry control method of (16),
   wherein the imaging unit further includes a third imaging portion and a fourth imaging portion;
   wherein the method further comprises applying the low-frequency demodulation signal to the third imaging portion with a first predefined delay after applying it to the first imaging portion, and applying the high-frequency demodulation signal to the fourth imaging portion with a second predefined delay after applying it to the second imaging portion.
(18) The time-of-flight image sensor circuitry control method of (16) or (17), wherein the method further comprises:
   switching between a first and a second floating diffusion of the second imaging portion according to the applied high-frequency demodulation signal.
(19) The time-of-flight image sensor circuitry control method of any one of (16) to (18),
   wherein, when the low-frequency demodulation signal is applied in the second state to the first imaging portion, the high-frequency demodulation signal is applied to the second imaging portion.
(20) The time-of-flight image sensor circuitry control method of (19), wherein the method further comprises:
   switching between a first and a second floating diffusion of the first imaging portion according to the applied low-frequency demodulation signal.
(21) The time-of-flight image sensor circuitry control method of any one of (16) to (18),
   wherein, when the low-frequency demodulation signal is applied in the second state to the second imaging portion, the high-frequency demodulation signal is applied to the first imaging portion.
(22) The time-of-flight image sensor circuitry control method of (21),
   wherein the first and the second imaging portions each include an overflow gate; and
   wherein the method further comprises:
      switching between a first and a second floating diffusion of the first imaging portion according to the applied high-frequency demodulation signal; and
      activating the overflow gate of the respective first or second imaging portion according to the applied low-frequency demodulation signal.
(23) The time-of-flight image sensor circuitry control method of (21) or (22),
   wherein the imaging unit further includes a third imaging portion and a fourth imaging portion; and
   wherein the method further comprises:
      applying the low-frequency demodulation signal to the third imaging portion with a first predefined delay after applying it to the first imaging portion, and to the fourth imaging portion with the first predefined delay after applying it to the second imaging portion; and
      applying the high-frequency demodulation signal to the third imaging portion with a second predefined delay after applying it to the first imaging portion, and to the fourth imaging portion with the second predefined delay after applying it to the second imaging portion.
(24) The time-of-flight image sensor circuitry control method of (23),
   wherein the second predefined delay corresponds to a 90° phase shift of the high-frequency demodulation signal.
(25) The time-of-flight image sensor circuitry control method of (23) or (24),
   wherein the first predefined delay corresponds to a 90° phase shift of the low-frequency demodulation signal.
(26) The time-of-flight image sensor circuitry control method of any one of (23) to (25),
   wherein the first predefined delay corresponds to an integer multiple of a half period of the high-frequency demodulation signal.
(27) The time-of-flight image sensor circuitry control method of (23) or (24),
   wherein the first predefined delay deviates from a 90° phase shift of the low-frequency demodulation signal by a 90° phase shift of the high-frequency demodulation signal.
(28) The time-of-flight image sensor circuitry control method of any one of (16) to (27),
   wherein a frequency of the high-frequency demodulation signal is an integer multiple of a frequency of the low-frequency demodulation signal.
(29) The time-of-flight image sensor circuitry control method of any one of (16) to (28),
   wherein a frequency of the high-frequency demodulation signal is an odd multiple of two times a frequency of the low-frequency demodulation signal.
(30) The time-of-flight image sensor circuitry control method of any one of (16) to (29),
   further comprising generating depth data based on the first and the second imaging portions in a single shot.
(31) A computer program comprising program code causing a computer to perform the method according to anyone of (16) to (30), when being carried out on a computer.
(32) A non-transitory computer-readable recording medium that stores therein a computer program product, which, when executed by a processor, causes the method according to anyone of (16) to (30) to be performed.

1. A time-of-flight image sensor circuitry,
comprising an imaging unit including a first imaging portion and a second imaging portion,
wherein the circuitry is further configured to:
apply a low-frequency demodulation signal having a first state and a second state, and
apply a high-frequency demodulation signal,
wherein, when the low-frequency demodulation signal is applied in the first state to the first imaging portion, the high-frequency demodulation signal is applied to the second imaging portion.

2. The time-of-flight image sensor circuitry of claim 1, wherein the circuitry is further configured to:
switch between a first and a second floating diffusion of the second imaging portion according to the applied high-frequency demodulation signal.

3. The time-of-flight image sensor circuitry of claim 1,
wherein, when the low-frequency demodulation signal is applied in the second state to the first imaging portion, the high-frequency demodulation signal is applied to the second imaging portion.

4. The time-of-flight image sensor circuitry of claim 3, wherein the circuitry is further configured to:
switch between a first and a second floating diffusion of the first imaging portion according to the applied low-frequency demodulation signal.

5. The time-of-flight image sensor circuitry of claim 1,
wherein, when the low-frequency demodulation signal is applied in the second state to the second imaging portion, the high-frequency demodulation signal is applied to the first imaging portion.

6. The time-of-flight image sensor circuitry of claim 5,
wherein the first and the second imaging portions each include an overflow gate; and
wherein the circuitry is further configured to:
switch between a first and a second floating diffusion of the first imaging portion according to the applied high-frequency demodulation signal; and
activate the overflow gate of the respective first or second imaging portion according to the applied low-frequency demodulation signal.

7. The time-of-flight image sensor circuitry of claim 5,
wherein the imaging unit further includes a third imaging portion and a fourth imaging portion; and
wherein the circuitry is further configured to:
apply the low-frequency demodulation signal to the third imaging portion with a first predefined delay after applying it to the first imaging portion, and to the fourth imaging portion with the first predefined delay after applying it to the second imaging portion; and
apply the high-frequency demodulation signal to the third imaging portion with a second predefined delay after applying it to the first imaging portion, and to the fourth imaging portion with the second predefined delay after applying it to the second imaging portion.

8. The time-of-flight image sensor circuitry of claim 7,
wherein the first predefined delay corresponds to an integer multiple of a half period of the high-frequency demodulation signal.

9. The time-of-flight image sensor circuitry of claim 1,
wherein a frequency of the high-frequency demodulation signal is an integer multiple of a frequency of the low-frequency demodulation signal.

10. The time-of-flight image sensor circuitry of claim 1,
further configured to generate depth data based on the first and the second imaging portions in a single shot.

11. A time-of-flight image sensor circuitry control method for controlling a time-of-flight image sensor circuitry including an imaging unit including a first imaging portion and a second imaging portion,
wherein the method further comprises:
applying a low-frequency demodulation signal having a first state and a second state, and
applying a high-frequency demodulation signal,
wherein, when the low-frequency demodulation signal is applied in the first state to the first imaging portion, the high-frequency demodulation signal is applied to the second imaging portion.

12. The time-of-flight image sensor circuitry control method of claim 11, wherein the method further comprises:
switching between a first and a second floating diffusion of the second imaging portion according to the applied high-frequency demodulation signal.

13. The time-of-flight image sensor circuitry control method of claim 11,
wherein, when the low-frequency demodulation signal is applied in the second state to the first imaging portion, the high-frequency demodulation signal is applied to the second imaging portion.

14. The time-of-flight image sensor circuitry control method of claim 13, wherein the method further comprises:
switching between a first and a second floating diffusion of the first imaging portion according to the applied low-frequency demodulation signal.

15. The time-of-flight image sensor circuitry control method of claim 11,
wherein, when the low-frequency demodulation signal is applied in the second state to the second imaging portion, the high-frequency demodulation signal is applied to the first imaging portion.

16. The time-of-flight image sensor circuitry control method of claim 15,
wherein the first and the second imaging portions each include an overflow gate; and
wherein the method further comprises:
switching between a first and a second floating diffusion of the first imaging portion according to the applied high-frequency demodulation signal; and
activating the overflow gate of the respective first or second imaging portion according to the applied low-frequency demodulation signal.

17. The time-of-flight image sensor circuitry control method of claim 15,
wherein the imaging unit further includes a third imaging portion and a fourth imaging portion; and
wherein the method further comprises:
applying the low-frequency demodulation signal to the third imaging portion with a first predefined delay after applying it to the first imaging portion, and to the fourth imaging portion with the first predefined delay after applying it to the second imaging portion; and
applying the high-frequency demodulation signal to the third imaging portion with a second predefined delay after applying it to the first imaging portion, and to the fourth imaging portion with the second predefined delay after applying it to the second imaging portion.

18. The time-of-flight image sensor circuitry control method of claim 17,
wherein the first predefined delay corresponds to an integer multiple of a half period of the high-frequency demodulation signal.

19. The time-of-flight image sensor circuitry control method of claim 11,
wherein a frequency of the high-frequency demodulation signal is an integer multiple of a frequency of the low-frequency demodulation signal.

20. The time-of-flight image sensor circuitry control method of claim 11,
further comprising generating depth data based on the first and the second imaging portions in a single shot.
